(19) United States
(12) Patent Application Publication
(10) Pub. No.: US 2013/0110811 A1
(43) Pub. Date: May 2, 2013

(54) COMPUTER AND METHOD FOR MAKING SEARCH ENGINE SEARCH RESOURCE OF COMPUTER SYSTEM INCLUDING STORAGE SYSTEM AND FOR DISPLAYING RESULT OF THE SEARCH

(71) Applicants: Takeshi Saito, Yokohama (JP); Tomoto Washio, Sango (JP)

(72) Inventors: Takeshi Saito, Yokohama (JP); Tomoto Washio, Sango (JP)

(73) Assignee: Hitachi, Ltd.

(21) Appl. No.: 13/390,469

(22) PCT Filed: Jan. 18, 2012
(86) PCT No.: PCT/JP2012/000284

§ 371 Date: Feb. 14, 2012

Related U.S. Application Data
(60) Provisional application No. 61/552,845, filed on Oct. 28, 2011.

(51) Int. Cl. G06F 17/30

(52) U.S. Cl. 707/708; 707/E17.109

(57) ABSTRACT

Computer stores category management information including information indicating search order of search range for each category. The computer outputs display information of category specification part that receives specification of a user desired category in which a special category is all of the plurality of categories specified by default. The computer makes the search engine execute a search that a category that is a search range is switched in an order that conforms to a search order indicated by the category management information in the case when computer receives a search execution instruction in a state in which the special category is specified. The computer makes a display that indicates the category of a search hit in an active state that is a selectable state and makes a display of indicating the category of a non-search hit in an inactive state that is a non-selectable state.

### TECHNICAL FIELD

The present invention relates to a search of a resource of a computer system that includes a storage system.

### BACKGROUND ART

A technique for searching an object that is corresponded to a search condition that has been input is publicly known. The search condition is a keyword for instance (see Patent Literature 1 for instance).

### CITATION LIST

### Patent Literature

PTL 1: Japanese Patent Application Laid-Open Publication No. 2009-064120

### SUMMARY

### Technical Problem

A computer system that includes a storage system includes at least one storage system or at least one host computer (hereafter referred to as a host) that is coupled to at least one storage system in addition to at least one storage system in general. As a category of a resource (a physical or logical composition element) of a computer system, there can be mentioned for instance (1) a host, (2) a switch that is disposed between a host and a storage system, (3) a communication port that is included in a storage system, (4) a logical volume that is included in a storage system, (5) a pool that is provided with a storage region that is allocated to a virtual logical volume that conforms to Thin Provisioning, and (6) a parity group (that is also called a RAID (Redundant Array of Independent (or Inexpensive) Disks) group) that is configured by a plurality of storage devices, that is a basis of a logical volume, and that is included in a storage system.

In the case in which a plurality of desired resources of different categories is associated with each other, it is possible that a logical relationship for a storage system (for instance, a host, a logical volume that is accessed by the host, and a communication port that is used by the host in the case where the host accesses the logical volume) is constructed.

There is a search processing system that is configured to search a resource of a storage system in such a manner that a user can smoothly search a desired resource.

The search processing system receives a specification of a category from a user among categories of a plurality of types and searches a resource that is corresponded to a search condition that has been input by a user from categories that have been specified (to be precise, among a plurality of resources that belong to the category).

However, a category of a default is set to a search processing system and a user executes a search without specifying a category to the search processing system in some cases. In this case, the search processing system searches a resource that is corresponded to a search condition from a category of a default. There are following two results of the search:

(Result 1) a resource that is corresponded to a search condition cannot be found; and

(Result 2) although a resource that is corresponded to a search condition is found, the found resource is not a resource that is searched by a user.

The above (Result 1) is a result that may occur by necessity since a category that is desired by a user has not been specified.

The above (Result 2) may occur for the following reason in addition to that a category that is desired by a user has not been specified. That is, IDs that match each other perfectly or partially are imparted to a plurality of resources of different categories for a computer system in some cases. For instance, a “VM” that is an abbreviated expression of a virtual machine is included in the both IDs of a host that belongs to a category “host” and a logical volume that belongs to a category “logical volume” in some cases. In this case, in the case in which a category of a default is “host” and a user inputs “VM” as a search condition (a keyword) in order to search a logical volume that is provided with an ID that includes “VM” and makes a search processing system execute a search without specifying a “logical volume” as a category, the search processing system searches not a logical volume in which a “VM” is included in an ID but a host in which a “VM” is included in an ID.

### Solution of Problem

A computer stores the category management information that includes the information that indicates a search order that is an order of a search range for each category. The computer displays a category specification part that is an electronic screen part that receives a specification of a user desired category of a plurality of categories and in which a special category that means that all of the plurality of categories is a search range is specified by default. The computer makes the search engine execute a search in such a manner that a category that is a search range is switched in an order that conforms to a search order that is indicated by the category management information in the case in which the computer receives a search execution instruction in a state in which the special category is specified to the category specification part. The computer makes a display of an object that indicates the category of a search hit be in an active state that is a selectable state and makes a display of an object that indicates the category of a non-search hit be in an inactive state that is a non-selectable state.

The search hit means that at least X resources (X is a natural number and can be a fixed value or a user arbitrary variable number) that are corresponded to the search condition have been found. The non-search hit can mean that at least X resources that are corresponded to the search condition have not been found.

The search engine can be included in the computer, or can be included in a first remote computer (such as a server) that is coupled to the computer.

The screen part and the search result can be displayed on a display device, and an input of a search condition and an instruction of a search execution can be executed by an input device. The display device and the input device can be included in the computer, or can be included in a second remote computer that is coupled to the computer. In the latter case, the second computer can function as a display device and an input device for the computer that is provided with a control device.

Moreover, an action of “display” of a control device (and a computer that is provided with the control device) can be any one of an action of the control device for displaying a screen part or the like on a display device of a computer that is provided with the control device and an action of the control device for transmitting the display information of a screen part or the like that is displayed on the display device to the second computer that is provided with the control device. In the case in which the second computer receives the display information, the second computer can display a screen part or the like that is indicated by the display information on the display device.

### BRIEF DESCRIPTION OF DRAWINGS

FIG. 1 is a configuration diagram showing a search processing system in accordance with an embodiment.

FIG. 2 is a configuration diagram showing a search category table in accordance with an embodiment.

FIG. 3A is a configuration diagram showing a storage system table in accordance with an embodiment. FIG. 3B is a configuration diagram showing a volume category table in accordance with an embodiment. FIG. 3C is a configuration diagram showing a pool category table in accordance with an embodiment.

FIG. 4 is a view showing an example of a search screen in accordance with an embodiment.

FIG. 5 is a view showing an example of a search screen in searching in accordance with an embodiment.

FIG. 6 is a view showing an example of a search screen at a time point when a search processing of a category “Parity Group” is completed in accordance with an embodiment.

FIG. 7 is a view showing an example of a detailed view screen in searching in accordance with an embodiment.

FIG. 8 is a view showing an example of a search screen after a recovery in accordance with an embodiment.

FIG. 9 is a flowchart of a search display processing in accordance with an embodiment.

FIG. 10 is a flowchart of an initializing processing of a search category table in accordance with an embodiment.

FIG. 11 is a flowchart of a search processing in accordance with an embodiment.

FIG. 12 is a flowchart of a search recovery processing in accordance with an embodiment.

FIG. 13 is a flowchart of a re-search processing in accordance with an embodiment.

FIG. 14 is a view showing an example of a search screen before an execution of a re-search processing in accordance with an embodiment.

FIG. 15 is a view showing an example of a search screen immediately after an execution of a re-search processing in accordance with an embodiment.

FIG. 16 is a view showing an example of a search screen during an execution of a re-search processing in accordance with an embodiment.

FIG. 17 is a view showing an example of a search screen in accordance with a first modified example of the embodiment.

FIG. 18 is a view showing a first status of a search screen in accordance with a second modified example and a third modified example of the embodiment.

FIG. 19 is a view showing a second status of a search screen in accordance with a second modified example of the embodiment.

FIG. 20 is a view showing a third status of a search screen in accordance with a second modified example of the embodiment.

FIG. 21 is a view showing a second status of a search screen in accordance with a third modified example of the embodiment.

FIG. 22 is a view showing a third status of a search screen in accordance with a third modified example of the embodiment.

FIG. 23 is a view showing a fourth status of a search screen in accordance with a third modified example of the embodiment.

### DESCRIPTION OF EMBODIMENTS

An embodiment and some modified examples of the present invention will be described below in detail with reference to the drawings. The embodiment and the modified examples that will be described in the following do not restrict the present invention in accordance with the claims, and all of elements and combinations thereof that will be described in the embodiment are not necessarily essential for means for solving the problems of the invention.

In the following descriptions, while a wide variety of information will be described in the expression of “aaa table” in some cases, a wide variety of information can be represented by any data structure other than a table. In order to indicate that a wide variety of information is not depended on a data structure, the expression of “aaa table” can also be referred to as “aaa information”.

In the following descriptions, the processing will be described while a “program” is handled as a subject in some cases. In the case in which the program is executed by a processor (for instance, a CPU (Central Processing Unit)), the processor executes the predetermined processing by using a storage resource (such as a memory) and/or a communication interface device (such as an I/F) as it decides proper. Consequently, a subject of a processing can also be a processor. The processing that is described while a program is handled as a subject can also be a processing that is executed by a processor or a system that is provided with the processor (such as a client and a storage management server). Moreover, the processor can include a hardware circuit that executes a part or a whole of a processing that is executed by the processor. A program can be installed from a program source to each of apparatuses. The program source can be a program distribution server or a storage medium for instance.

In the following descriptions, a system that is configured to search a resource of a computer system that includes a storage system is called a search processing system in some cases. The search processing system is configured by at least one computer. In the embodiment and the modified examples that will be described in the following, a client that is provided with an input device that is configured to input a search condition and a display device that is configured to display a search result and a server that is configured to search a resource (a search target) that is corresponded to the input search condition are configured separately. However, a client and a server can also be configured in an integrated manner. An input device is at least one of a keyboard, a pointing device, and a touch panel for instance. However, an input device can also be other device. Moreover, an output device is a display device or a touch panel for instance. However, an output device can also be other device. A server can also be provided with a serial interface or an Ethernet interface (Ethernet is a registered trademark) as an input device. A client described above can be coupled to an input/output device of a server, and the client can execute a display or receive an input in the case in which a server transmits the information for a display to a client or receives the information for an input from a client.

Moreover, a user that executes a search of a resource and a user that associates resources with each other can be the same or can be different from each other.

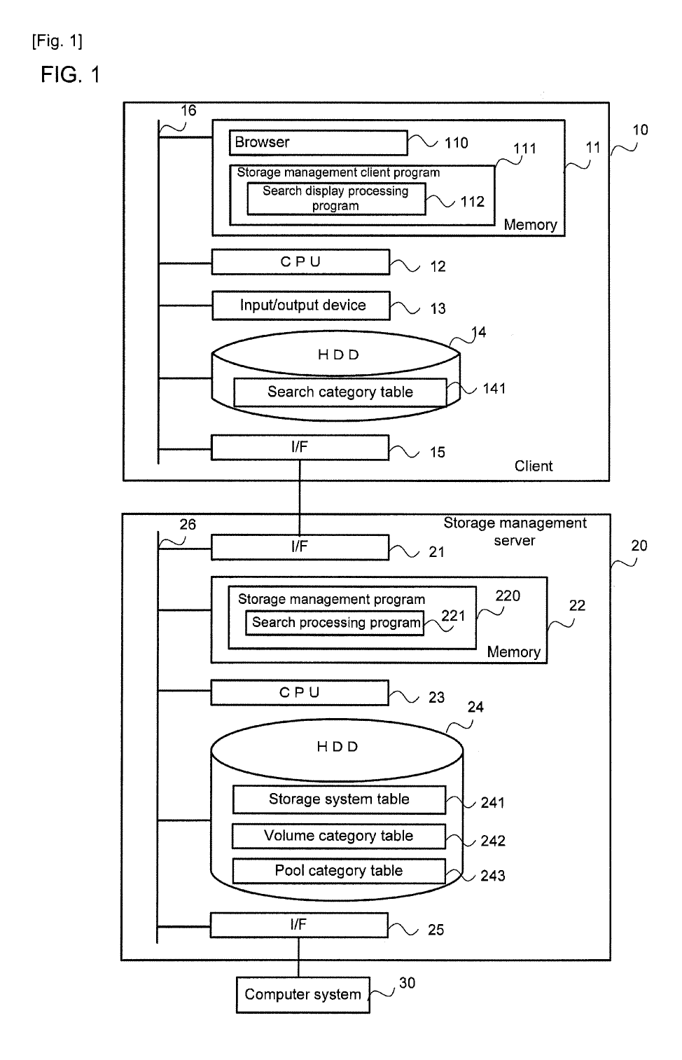

FIG. 1 is a configuration diagram showing a search processing system in accordance with an embodiment.

The search processing system is provided with a storage management server (hereafter referred to as a server) 20 and a client 10 that is coupled to the server 20. For instance, the client 10 can be coupled to the server 20 via a communication network (such as a LAN (Local Area Network)).

A computer system 30 can be coupled to the server 20. The server 20 can be coupled to the computer system 30 via a communication network (such as a LAN). The computer system 30 in accordance with the present embodiment includes at least one storage system and at least one host computer (hereafter referred to as a host) that is coupled to at least one storage system. The storage system is provided with a controller that is provided with a plurality of communication ports and a plurality of parity groups that are coupled to the controller. The parity group is configured by a plurality of storage devices (such as an SSD (Solid State Drive) and an HDD (Hard Disk Drive)). A logical volume is formed based on the parity group. The logical volume can be provided to the host or can be a configuration element of a pool. The logical volume that configures a pool is divided into at least two storage regions. A storage region is allocated to a virtual logical volume that conforms to Thin Provisioning from a pool.

The client 10 is a computer and is provided with a communication interface (I/F) 15, a storage device, and a control device that is coupled to the I/F 15 and the storage device. In the present embodiment, the storage device is a memory 11 and an HDD 14, and the control device is a CPU 12. The memory 11, the CPU 12, the input/output device 13, the HDD 14, and the OF 15 are coupled to each other via a bus 16. An auxiliary storage device such as the HDD 14 can exist outside the client 10.

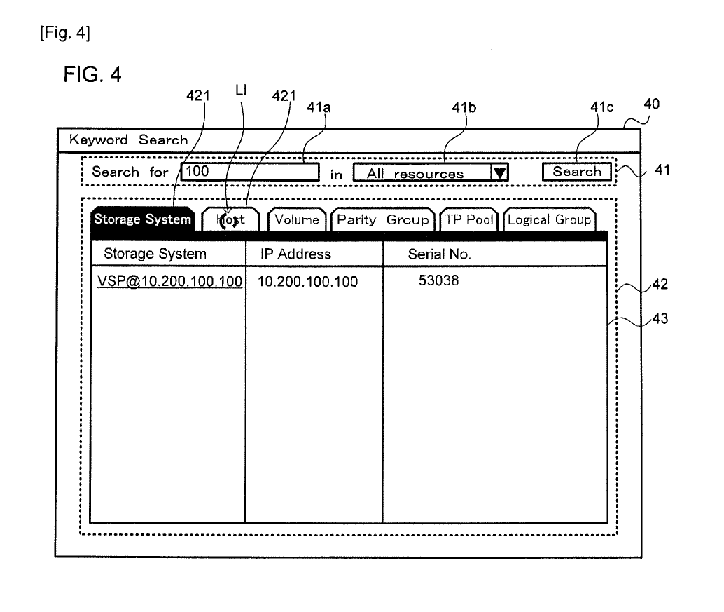

The memory 11 is a RAM (Random Access Memory) for instance, and stores a computer program that is executed by the CPU 12 and data that is used by the CPU 12. In the present embodiment, the memory 11 stores a known browser 110 that is configured to execute a basic processing of a communication and a screen display and a storage management client program (hereafter referred to as a client program) 111 that is configured to execute a storage management by using a function of the browser 110. The client program 111 includes a search display processing program 112 that is configured to execute a processing for displaying a search screen (see FIG. 4) or the like.

The input/output device 13 is an input device that is configured to receive an input from a user that uses the client 10 (for instance, a mouse and a keyboard) and an output device that is configured to display a screen that is configured by the browser 110 (for instance, a display device).

The CPU 12 executes a wide variety of processing by executing programs that have been stored into the memory 11.

The HDD 14 stores a wide variety of information. In the present embodiment, the HDD 14 stores a search category table 141. In the present embodiment moreover, the HDD 14 stores a search result (record) at a point of time of a search that is corresponded to the search category table 141.

The I/F 15 executes an intermediate processing of a communication with the server 20.

The server 20 is also a computer and is provided with communication interfaces (I/F) 21 and 25, a storage device, and a control device that is coupled to the I/F 21 and the storage device. In the present embodiment, the storage device is a memory 22 and an HDD 24, and the control device is a CPU 23. The I/F 21, the memory 22, the CPU 23, the HDD 24, and the I/F 25 are coupled to each other via a bus 26. An auxiliary storage device such as the HDD 24 can exist outside the server 20. The I/F 21 and the I/F 25 can be formed in an integrated manner.

The I/F 21 executes an intermediate processing of a communication with the client 10.

The memory 22 is a RAM for instance, and stores programs that are executed by the CPU 22 and data that is used by the CPU 23. In the present embodiment, the memory 22 stores a storage management program 220 that is configured to execute a storage management. The storage management program 220 includes a search processing program 221 that is configured to execute a search processing. The CPU 23 executes a wide variety of processing by executing programs that have been stored into the memory 22.

The HDD 24 stores a wide variety of information. In the present embodiment, the HDD 24 stores tables for resources of a plurality of categories that are related to the storage system 30 such as a storage system table 241, a volume category table 242, and a pool category table 243. The necessary information is collected from an apparatus that is included in the storage system 30 (for instance, at least one of the storage system, the host, and a switch that is disposed between the storage system and the host) by a program 220 on a regular basis (or on an irregular basis), and tables for resources of a plurality of categories is updated based on the information that has been collected for instance. The information that is stored into a table can be acquired immediately after the configuration of the storage system 30 is modified (for instance, after a parity group is added or removed, or after a logical volume is added or remove). By such a configuration, the information of a table can be maintained to be as latest as possible. The information that has been transmitted from the storage system 30 is received by the I/F 25, and is reflected to a table of a category with which the information is associated by the program 220.

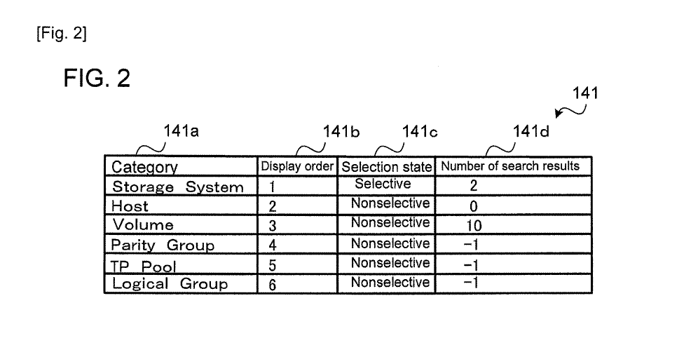

FIG. 2 is a configuration diagram showing the search category table 141.

The search category table 141 stores a record that is provided with the fields of a category 141a, a display order 141b, a selection state 141c, and the number of search results 141d.

The category 141a stores the information that indicates a category name. A plurality of categories in accordance with the present embodiment is Storage System, Host, Volume (a logical volume), Parity Group, TP Pool (a pool described before, TP is an abbreviation of Thin Provisioning), and Logical Group.

The display order 141b stores the information that indicates an order of an arrangement of a tab that is displayed on a search screen (a tab in which a category name that has been stored into the category 141a is displayed). In the present embodiment, a category that is a search range is switched in an order that conforms to the display order. That is, a category of an earlier display order is in a search range earlier. In other words, the display order is an order that is a search range, and the order is also adopted for an arrangement order. In a default setting, the display order can be an earlier order (an order that is a search range earlier in priority) in the case in which there are more types of operations of a user.

The selection state 141c stores the information that indicates whether or not a category for displaying a search result on the most front face of a tab screen 43 is selected (not selected). For instance, in the case in which a specification of a tab is received through an input device by a user operation for one of tabs of a selection enable state (an active state), the search display processing program 112 stores “Selective” in a selection state of the category and “Nonselective” in a selection state of other category. Moreover, the search display processing program 112 executes a processing to a tab in the selection state in such a manner that the search display processing program 112 displays a screen range that includes the specified tab on the most front face.

The number of search results 141d stores the information that indicates the number of search results, that is, the number of resources that are corresponded to the search condition (that are hit) in a category. In the present embodiment, “−1” is stored as the number of search results, as for a category that is not a search range. A category of an earliest display order among a plurality of categories in which the number of search results is “−1” is a category that is searched in progress. In the present embodiment moreover, a tab of a category in which the number of search results is equal to or larger than 1 is in an active state (a selection state or a selection enable state), and a tab of a category in which the number of search results is 0 or −1 is in an inactive state (a selection disable state). As described above, a judgment of an active state or an inactive state can be enabled by the number of search results. However, the search category table 141 can also be provided with a column that indicates an active state or an inactive state.

The following items can be found from the table 141 shown in FIG. 2:

(*) For the category “Storage System”, a tab of the category exists first in a tab arrangement, the tab is in an active state, and there are two resources that are corresponded to the search condition for the category. Moreover, the category “Storage System” is selected as a category in a selection state, that is, a category for displaying a search result on the most front face of the tab screen 43.

(*) For the category “Host”, although a tab of the category is supposed to exist second in a tab arrangement, a resource that is corresponded to the search condition has not been found for the category, whereby the tab is in an inactive state.

(*) For the category “Parity Group”, a tab of the category exists fourth in a tab arrangement, and a display order is earliest in categories in which the number of search results is“−1”. Consequently, it is found that a category is still searched in progress and the tab is in an inactive state (a state that indicates being searched in progress).

(*) For the category “TP Pool”, it is found that a tab of the category exists fifth in a tab arrangement and a search processing has not yet been started for the category, whereby the tab is in an inactive state.

In the above descriptions, that the tab is in an “active state” means that an input device is operated and the tab is in a state in which the tab can be specified (for instance, a state in which a screen range that includes the specified tab is displayed on the most front face). On the other hand, that the tab is in an “inactive state” means that an input device is operated and the tab is in a state in which the tab cannot be specified, for instance, a state in which a tab is displayed in a display attribute that is different from that of a tab in an active state or a state in which a category that is corresponded to the tab is searched in progress. As a display attribute, there can be mentioned for instance a color of a tab, a font of a character of a category name that is displayed in a tab, a shape of a tab, a transmittance of a tab (and a character). A transmittance is a transmittance that is smaller than an active state. For instance, in the case in which a transmittance is smaller than 100% and larger than N % (N is a transmittance in an active state and is a value that is equal to or larger than 0), a tab is in a state of translucence. In the case in which a transmittance is 100%, a tab is in a state in which the tab has been visually disappeared. In the case in which a search processing is started and a tab of a category in which a selection state has already been Selective becomes in an inactive state, a search processing is executed in a state in which a screen range that includes the tab is displayed on the most front face unless a specification to other tab is received via an input device.

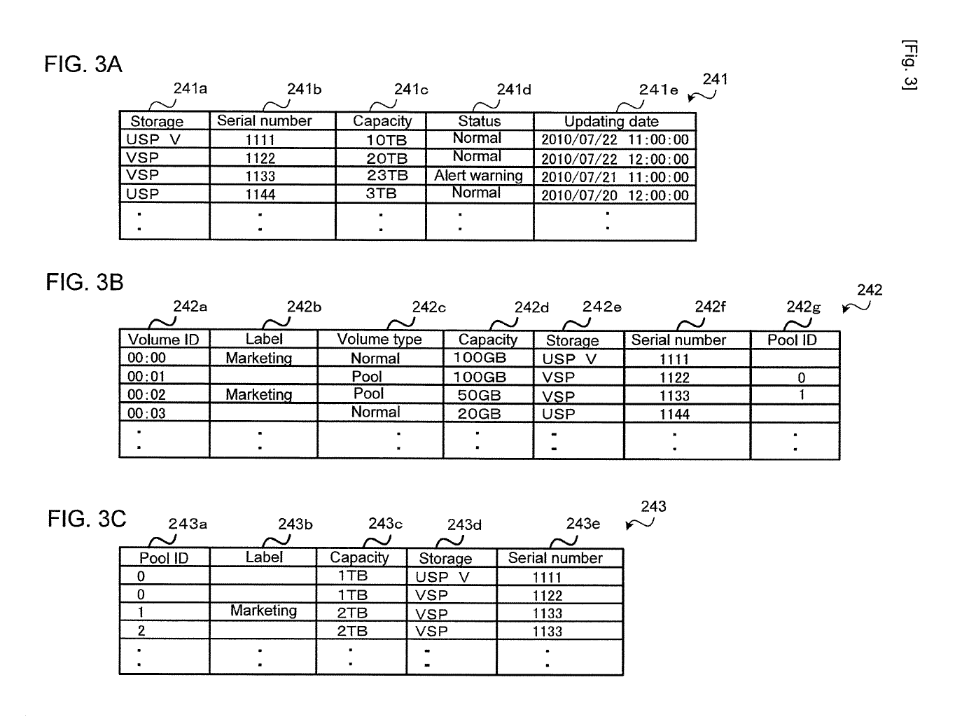

FIG. 3A is a configuration diagram showing a storage system table 241.

The storage system table 241 stores a record that is provided with the fields of a storage 241a, a serial number 241b, a capacity 241c, a status 241d, and an updating date 241e.

The storage 241a stores the information that indicates a storage system name.

The serial number 241b stores the information that indicates a serial number of a storage system.

The capacity 241c stores the information that indicates a storage capacity of a storage system.

The status 241d stores the information that indicates a status (a state) of a storage system.

The updating date 241e stores the information that indicates a date when a record is updated. The “date” includes at least one of a year, a month, a day, an hour, a minute, and a second (that can include a second after the decimal point).

For instance, for the top record of the storage system table 241, a serial number of a storage system in which a storage system name is “USP V” is “1111”, a capacity is “10 TB”, a status is “Normal”, and an updating date of the record is “2010/07/22 11:00:00”.

FIG. 3B is a configuration diagram showing a volume category table 242.

The volume category table 242 stores a record that is provided with the fields of a volume ID 242a, a label 242b, a volume type 242c, a capacity 242d, a storage 242e, a serial number 242f, and a pool ID 242g.

The volume ID 242a stores the identification information (ID) of a logical volume.

The label 242b stores a label of a logical volume (for instance, the information that indicates a use application of a logical volume).

The volume type 242c stores the information that indicates a type of a logical volume.

The capacity 242d stores the information that indicates a capacity of a logical volume.

The storage 242e stores the information that indicates a storage system name of a storage system that is provided with a logical volume.

The serial number 242f stores a serial number of a storage system that is provided with a logical volume.

The pool ID 242g stores an ID of a pool that is provided with a logical volume. In the case in which a logical volume is not a volume that has been stored into a pool, nothing is stored as a pool ID.

For instance, for the top record of the volume category table 242, a logical volume that is provided with a volume ID of “00:00” is in a storage system in which a label is “Marketing”, a volume type is “Normal”, a capacity is “100 GB”, a storage system name is “USP V”, and a serial number is “1111”, and is not a logical volume that configures a pool.

FIG. 3C is a configuration diagram showing a pool category table 243.

The pool category table 243 stores a record that is provided with the fields of a pool ID 243a, a label 243b, a capacity 243c, a storage 243d, and a serial number 243e.

The pool ID 243a stores the identification information (ID) of a pool.

The label 243b stores a label of a pool.

The capacity 243c stores a capacity of a pool.

The storage 243d stores a storage system name of a storage system that is provided with a pool.

The serial number 243e stores a serial number of a storage system that is provided with a pool.

For instance, for the top record of the pool category table 243, a pool that is provided with a pool ID of “0” is in a storage system in which there is no label, a capacity is “1 TB”, a storage system name is “USP V”, and a serial number is “1111”.

In the next place, a processing of a search processing system in accordance with the present embodiment will be described in the following.

An example of a search screen that is displayed on the input/output device 13 by the search display processing program 112 before a search is executed will be described in the following. In the present embodiment, a user makes a server 20 search a desired logical volume and/or a desired host through a client 10 in order to allocate a desired logical volume to a desired host.

FIG. 4 is a view showing an example of a search screen in accordance with an embodiment.

A search screen 40 is a screen that is displayed on the input/output device 13 by executing the search display processing program 112 by the client 10, and is a GUI (Graphical User Interface) in a quintessential way. The search screen 40 is provided with a search specification region 41 that is configured to receive a specification that is related to a search and a sub screen region 42 that is configured to display a progress situation and a result of the search.

The search specification region 41 displays a plurality of electronic screen parts such as a keyword input field 41a that is an input field of a keyword as a search condition (for instance, at least one code that includes at least one code of a numeric character, a character, and a symbol), a category pull-down menu 41b that is configured to receive a specification of a category as a search range, and a Search button 41c that is configured to receive an execution instruction of a search. The search screen 40 can also be provided with an electronic screen part (tool) that is configured to switch a perfect matching search (searching a resource to which the compared information that perfectly matches an input keyword has been allocated) and a partial matching search (searching a resource to which the compared information that partially matches an input keyword has been allocated). The compared information of a resource can be at least one of a storage system name, a serial number, a volume ID, and a label. A content of the compared information can be decided by default or by a user.

In the case in which an operation that means specifying a category that is desired by a user from a plurality of categories is executed, the category pull-down menu 41b displays a list of names of a plurality of categories that can be specified.

A tab screen 43 is displayed in the sub screen region 42. A display state of a tab 421 is different depending on a situation of a search processing for a category that is corresponded to the tab (for instance, whether or not being searched in progress, or a search has been completed and whether or not a resource that is corresponded to a search condition has been found).

An arrangement order of a tab is an order that conforms to a display order that is indicated by the table 141 shown in FIG. 2. For instance, tabs 421 are arranged in a horizontal direction from the left side in accordance with a display order in the figure. The display order is also an execution order of a search processing. That is, a search range transits in accordance with a display order. An arrangement of a tab can also be in a vertical direction.

There are some types of display modes of the tabs 421 as shown in FIG. 4.

For instance, a tab “Storage System” shown in FIG. 4 is a tab in an active state and in a selection state, and is a tab of a screen that is displayed on the most front face in the tab screen 43. The screen that is displayed on the most front face in the tab screen 43 displays the information that has been found from a category that is corresponded to the screen and that is related to a resource that is corresponded to a search condition.

A tab “Host” shown in FIG. 4 is a tab in an inactive state and is an object that means that a search is in progress for a category that is corresponded to the tab, for instance, a tab in which a loading icon LI is displayed.

Moreover, the tabs “Volume”, “Parity Group”, “TP Pool”, and “Logical Group” that are shown in FIG. 4 are tabs in an inactive state and is tabs in which a search has not yet been executed.

For the search screen 40, in the initial state, that is, in the first state after an initiation of a program, it is possible that a tab screen 43 is not displayed in the sub screen region 42, or a tab screen 43 can be displayed in a blank state. After a search condition is input to the input field 41a and a search processing is started, a display of the tab screen 43 can be transited.

As one characteristic of the present embodiment, a new category “All resources” is prepared. The category “All resources” is a category that means all categories other than “All resources” are a search range. For a category selection region 41b, the new category “All resources” is set as a default. By this configuration, even in the case in which a user who has input a search condition presses a “Search” button 41c without specifying a category, a search in which a category that is desired by a user is a search range is executed in a certain manner.

The present embodiment is provided with some other characteristics. While a transition of the search screen 40 will be described, other characteristics will also be described in an appropriate manner in the following. In the following descriptions, “a category in which at least X resources (X is a natural number and can be a fixed value or a user arbitrary variable number) that are corresponded to the search condition have been found as a result of a search processing” is referred to as “a search hit category”, and a tab that is corresponded to the search hit category is referred to as “a search hit tab”. Moreover, “a category in which at least X resources that are corresponded to the search condition have not been found as a result of a search processing” is referred to as “a non-search hit category”, and a tab that is corresponded to the non-search hit category is referred to as “a non-search hit tab”.

A loading icon LI is displayed in a tab 421 that is corresponded to a category that is being searched in progress as described above. In FIG. 4, in the case in which a search processing is completed for a category “Storage System”, the loading icon LI is moved to a tab “Host” on the immediate right side to the tab “Storage System” (that is, a search range is switched in accordance with a display order), a search processing in which a category “Host” that is corresponded to the tab “Host” is a search range is started.

A display mode of the tab 421 that is corresponded to a category in which a search processing has been completed is different depending on a result of the search processing. In FIG. 4, a tab “Storage System” is in an active state. This is because the tab is a search hit tab. Moreover, the tab “Storage System” is highlighted. This is because the tab is a tab in which a screen that indicates a result of the search is displayed on the most front face of the tab screen 43 (that is, a selection state of a category that is corresponded to the tab is “Selective”).

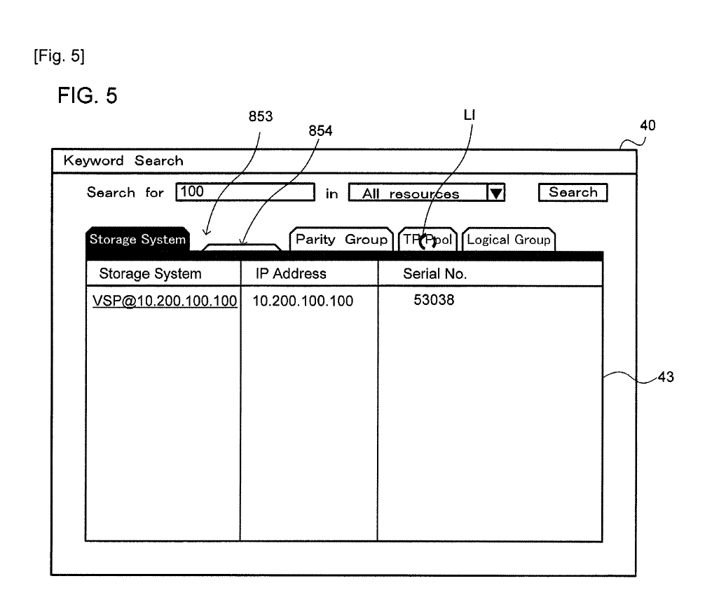

A switching of a search range proceeds, and a situation shown in FIG. 5 occurs. More specifically, a search processing has been completed for the categories “Storage System”, “Host”, “Volume”, and “Parity Group”, a search processing is being executed in progress for the category “TP Pool”, and a search processing has not yet started for the category “Logical Group”

In FIG. 5, the tab “Parity Group” is in an active state. This is because the tab is a search hit tab. Moreover, the tab “Parity Group” shown in FIG. 5 is not highlighted. This is because the tab is a tab in which a screen that indicates a result of the search is not displayed on the most front face of the tab screen 43 (that is, a selection state of a category that is corresponded to the tab is “Nonselective”).

In FIG. 5, the tab “Host” is in an inactive state, and is deleted from the tab screen 43 as shown by an arrow 853 for instance. This is because the tab is a non-search hit tab.

In FIG. 5 moreover, all tabs that exist on the right side from the tab “Host” that has been deleted are closed up to the left side (the leading head side) as shown by an arrow 853. In this case, a horizontal width of the entire tab group (a plurality of tabs) that is displayed on the tab screen 43 is longer than a horizontal length of the tab screen 43. Consequently, in the case in which a display of a category name of at least one tab has a problem (for instance, a part of a category name is not displayed, or a category name is reduced for a display), a problem of a display of a category name can be suppressed (for instance, all of category names is displayed, or a category name is displayed at the same magnification) by resizing a horizontal width of the at least one tab.

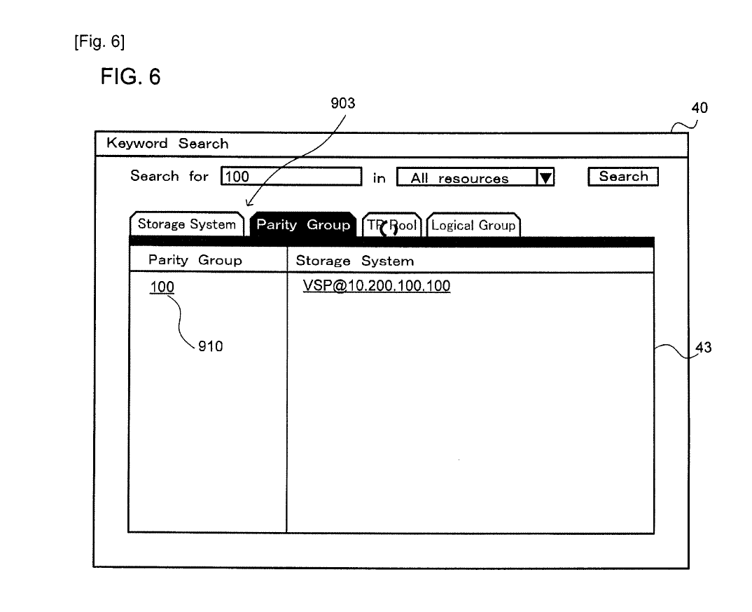

A non-search hit tab can be deleted in the wink of an eye after a search processing is completed. However in the present embodiment, a non-search hit tab is deleted by slow degrees with time. More specifically, like the tab “Volume” shown in FIG. 5, a non-search hit tab is moved downward by slow degrees by an animation and is deleted from the tab screen 43 (in FIG. 5, the tab “Volume” is in the state of being deleted in progress). After the tab “Volume” is deleted completely, all tabs that exist on the right side from the tab “Volume” are closed up to the left side (the leading head side) as shown in FIG. 6.

In FIGS. 4 to 6, since a tab that is corresponded to a search hit category is in an active state, a user can operate the input/output device 13 to select the category. On the other hand, since a tab that is corresponded to a non-search hit category is deleted, a user can easily comprehend that the category is a non-search hit, and the category is not selected by mistake.

Moreover, a tab that is corresponded to a category that is being searched in progress and a category that is waiting for a search processing is in an inactive state, tabs are arranged in a transit order of a search range, and a loading icon is displayed on a tab that is corresponded to a category that is being searched in progress. Consequently, a user can easily comprehend which category a search processing makes progress to.

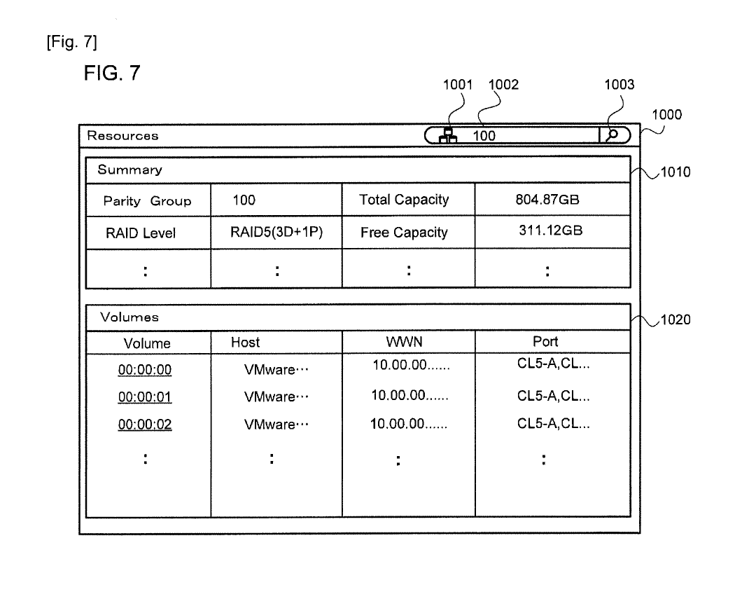

As shown in FIG. 6 for instance, at the point of time when a search processing of the category “Parity Group” is completed, the tab “Parity Group” in an active state is selected. The tab “Parity Group” is highlighted and a screen of the tab “Parity Group” is displayed on the most front face. The screen of the tab “Parity Group” displays a list of the information that is related to a resource that has been found in the search processing, and a link display 910 is executed to the information. In the case in which the link display 910 is specified by the input device, a detailed view screen (see FIG. 7) that displays the resource detailed information that conforms to the link display 910 is displayed. In this case, the search screen 40 is deleted (for instance, the search screen 40 is displayed on the back face of a view screen).

The detailed view screen 1000 shown in FIG. 7 displays a resource symbol 1001 that indicates a resource in a search, a keyword region 1002 in which a keyword is displayed, and a search start button 1003 for instructing a start of a search. In the keyword region 1002, a keyword that has been used in the last search is displayed in an initial state, and a new keyword can also be input since then. Moreover, the view screen 1000 displays a summary display region 1010 that displays a summary of a corresponded resource and a resource detail display region 1020 that displays a detail of a resource. A user can view the detailed information of a resource that is corresponded to the search condition from the view screen 1000.

The display 910 of a link to the information that is displayed on the view screen can include the information that is described in a field of the search category table 141 and a link to the information for instance. The search display processing program 112 can execute the link display in displaying a search result.

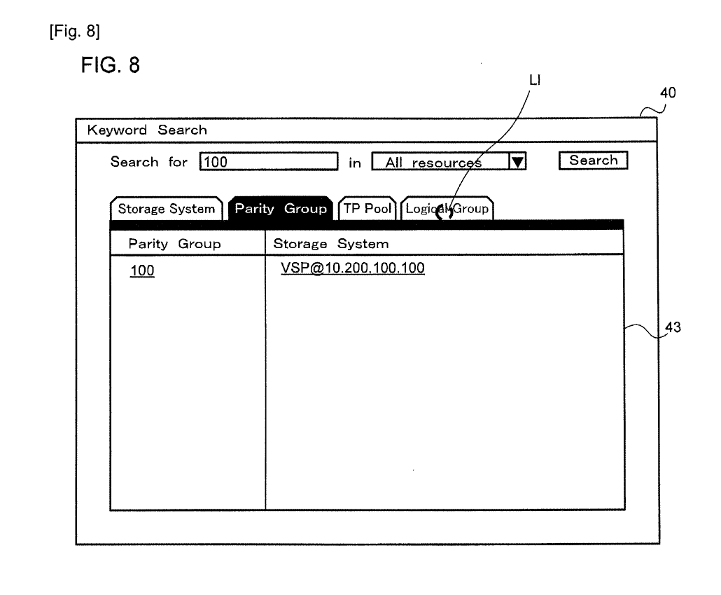

During a display of the view screen 1000, a search processing can be continued in a background, or a search processing can be suspended together with a display of the view screen 1000. In the case in which a predetermined operation is executed in the view screen 1000 shown in FIG. 7 (for instance, a search start button 1003 is pressed), the search screen 40 is displayed again. In the screen 40 shown in FIG. 8, a search processing progresses from a state before the view screen 1000 is displayed. This is because a loading icon LI transits from the tab “TP Pool” to the tab “Logical Group”.

A processing that is executed in the present embodiment will be described with reference to a flowchart in the following.

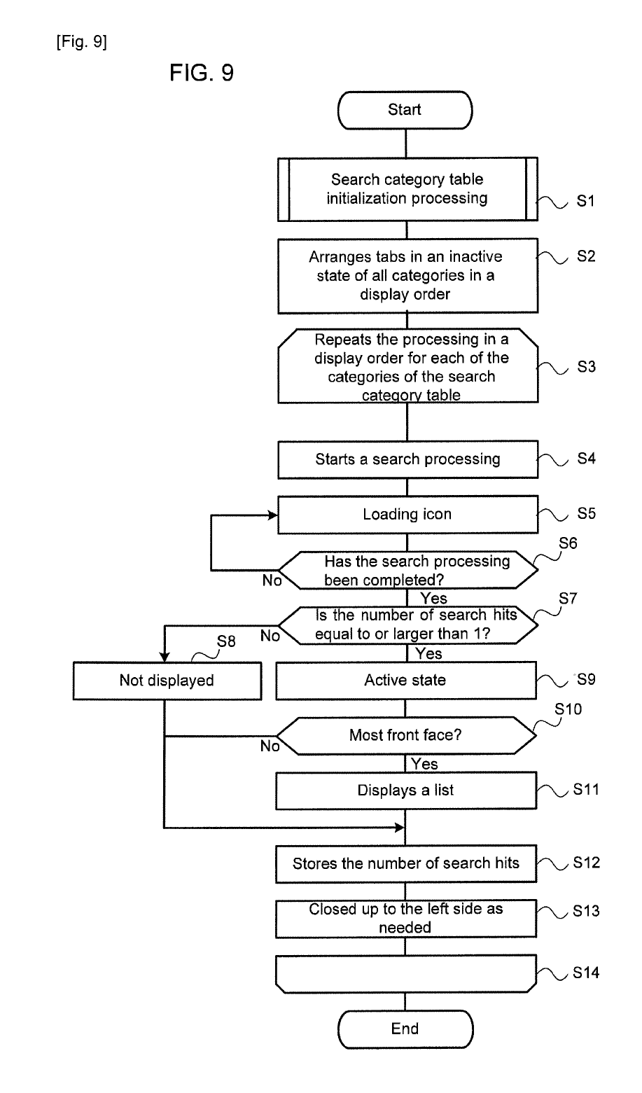

FIG. 9 is a flowchart of a search display processing in accordance with an embodiment.

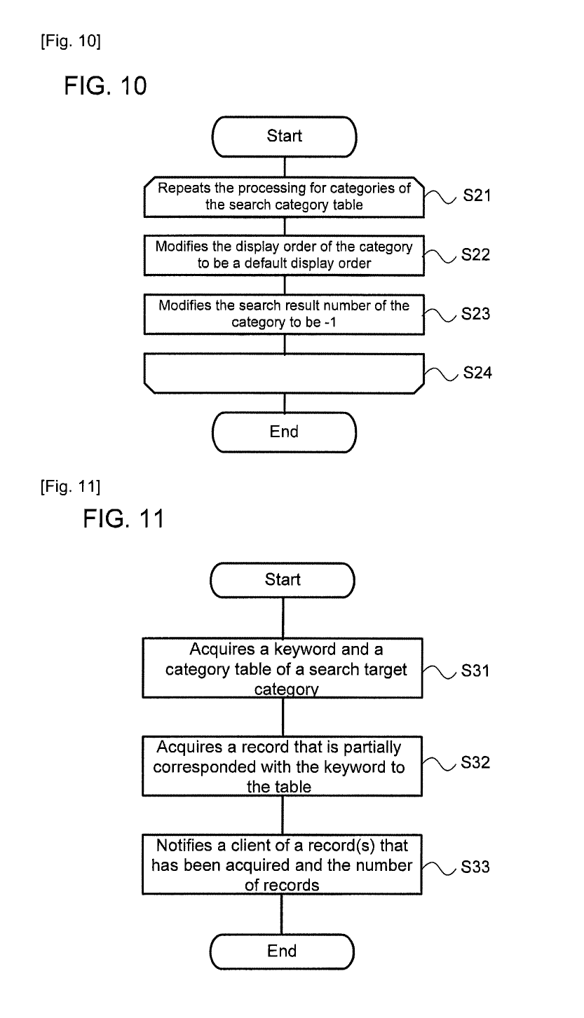

In the case in which a keyword is input as a search condition and a Search button 41c is pressed in the state in which a search range is a default (“All Resource”) in the search screen 40 in an initial state by an operation of a user to the input/output device 13, the search display processing program 112 (the CPU 12 that executes a browser 110 and the search display processing program 112 in a precise sense) executes a search category table initialization processing (see FIG. 10) (step S1).

In the next place, the search display processing program 112 arranges and displays tabs in an inactive state that are corresponded to all of categories from the left side of the tab display region 42 in an arrangement order that conforms to the display order 141b of the search category table 141 (step S2). In the present embodiment, for the tab, the entire of category names that are corresponded to the tab is displayed. In the case in which a tab that is corresponded to the category as a search range is displayed at an initial time point of a search as described above, a user can comprehend a search range (a category) before a search processing is started.

In the next place, the search display processing program 112 executes the processing of steps S3 to S14 in a repetitive manner in accordance with a display order of the display order 141b of a record for each of the categories of the record of the search category table 141.

In the first place, the search display processing program 112 transmits a start instruction of a search processing to a category of a processing target (the category) to a server 20 (step S4). The start instruction of a search processing includes a corresponded category name and a keyword for instance. By this configuration, a search processing (see FIG. 11) is executed in the server 20.

The search display processing program 112 displays a loading icon LI to a tab of the category to make the tab of the category in an inactive state (step S5), and judges whether or not the search processing has been completed, that is, whether or not the search result is received (step S6). In the case in which the search processing has not yet been completed (No in the step S6), the search display processing program 112 executes the step S5. On the other hand, in the case in which the search processing has been completed (Yes in the step S6), the search display processing program 112 judges whether or not the number of search hits is equal to or larger than 1 (step S7). In this flowchart, X is 1 in the expression of “a category in which at least X resources that are corresponded to the search condition have been found as a result of a search processing” described above. That is, “the number of search hits” is the number of resources that are corresponded to the search condition (the number of resources that have been found in a search processing).

As a result, in the case in which the number of search hits is not equal to or larger than 1 (No in the step S7), it means that a resource that is corresponded to the search condition does not exist in a result of a search processing. Consequently, the search display processing program 112 makes a tab of the corresponded category be not displayed (step S8), and proceeds to the processing of the step S12. In the present embodiment, in the case in which a tab is not displayed, an animation in which a tab that is displayed is moved downward and is disappeared is displayed, and a user is visually perceivable of that a tab is not displayed. A tab that is corresponded to an important category (for instance, a tab of a category in which a default display order is earlier) can be disappeared at a slow pace, and a tab that is corresponded to a category of no importance can be disappeared in a shorter time. In the case in which a screen that is provided with a tab that is not displayed is displayed on the most front face on the tab screen 43 (“Selective” has been stored into the selection state 141c of the corresponded category), the search display processing program 112 can store “Nonselective” into the selection state 141c of the corresponded category, and can store “Selective” into the selection state of a tab in which a display order is next for instance.

In the case in which the number of search hits is equal to or larger than 1 (Yes in the step S7), the search display processing program 112 makes the tab of the corresponded category in an active state (step S9), and judges whether or not a screen that is provided with the tab that is corresponded to the corresponded category is displayed on the most front face on the tab screen 43 (whether or not “Selective” has been stored into the selection state 141c of the corresponded category) (step S10).

In the case in which a result of the judgment is positive (Yes in the step S10), the search display processing program 112 displays a search result list (a list of the information that is related to the resource that has been found) on the screen that is provided with the tab that is corresponded to the corresponded category (step S11) and proceeds to the processing of the step S12.

The search display processing program 112 stores the number of search hits into the search result number 141d of the corresponded category of the search category table 141 (step S12). Moreover, in the case in which there is a free region on the left side of the corresponded category, the search display processing program 112 moves the tab that is corresponded to the corresponded category (and all of tabs that exist on the right side of the tab) to be closed up to the left side (step S13).

The search display processing program 112 executes the above processing in a repetitive manner in accordance with a display order of the display order 141b for each category of the record of the search category table 141, and then completes the processing.

By the above search display processing, since a non-search hit tab is deleted by an animation, a user can comprehend that there is no search hit for the target category. Moreover, since a tab is deleted, an ineffective operation in which a user selects a non-search hit tab can be prevented later. Moreover, since a tab is in an active state at a point of time when the search processing is completed and it is determined that search hit has been obtained, even in the case in which the search processing has not been completed for other categories, a user can display a search result of a category that is corresponded to the tab on the tab screen 43 by selecting the tab in an active state. A user can view the search result of the desired category in an expeditious way.

In the above processing, the processing of the step S13 is executed in a repetitive processing to each category (steps S3 to S14). However, after a repetitive processing to all of categories is completed, the step S13 can be executed for instance.

FIG. 10 is a flowchart of an initializing processing of a search category table (the step S1 in FIG. 9).

The search display processing program 112 repeats the processing of the steps S21 to S24 for each of the categories (each of the records) of the search category table 141 in the initializing processing of a search category table. More specifically, the search display processing program 112 modifies the display order 141b of a record of the category of a processing target (the corresponded category) be a default display order (step S22), and modifies a value in the search result number 141d to be “−1” that indicates that a search is not executed (step S23). Moreover, the search display processing program 112 can modify a value in the selection state 141c to be “Selective” for a category in which a display order is 1 and “Nonselective” for other categories.

FIG. 11 is a flowchart of a search processing in accordance with an embodiment.

For the search processing, a search processing program 221 of the server 20 acquires a keyword and a category name of a category of a search target from a search request that has been received from a client 10 and refers to a category table in which the resource information for a category of a category name is stored (for instance, a storage system table 241 in the case in which a category name is a storage, and a volume category table 242 in the case in which a category name is a volume) (step S31).

In the next place, the search processing program 221 acquires a record that is partially corresponded with the keyword to the category table that has been acquired (step S32). As a field for judging a partial correspondence with the keyword, there are all fields of a record and a part of fields. In the case in which the field is a part of fields of a record for instance, the fields are a storage name, an IP address, and a serial number in the case of a storage system category table, the fields are a host name, an IP address, and WWN in the case of a category table of a host, the fields are an ID and a label in the case of the category table of a volume, the field is an ID in the case of a category table of a parity group, the fields are an ID and a label in the case of the category table of a pool, and the fields are a logical group name and a description in the case of the category table of a logical group.

In the next place, the search processing program 221 notifies the client 10 of each record that has been acquired and the number of records (step S33). By this step, a search result for a category of which a search is requested to the client 10 can be returned.

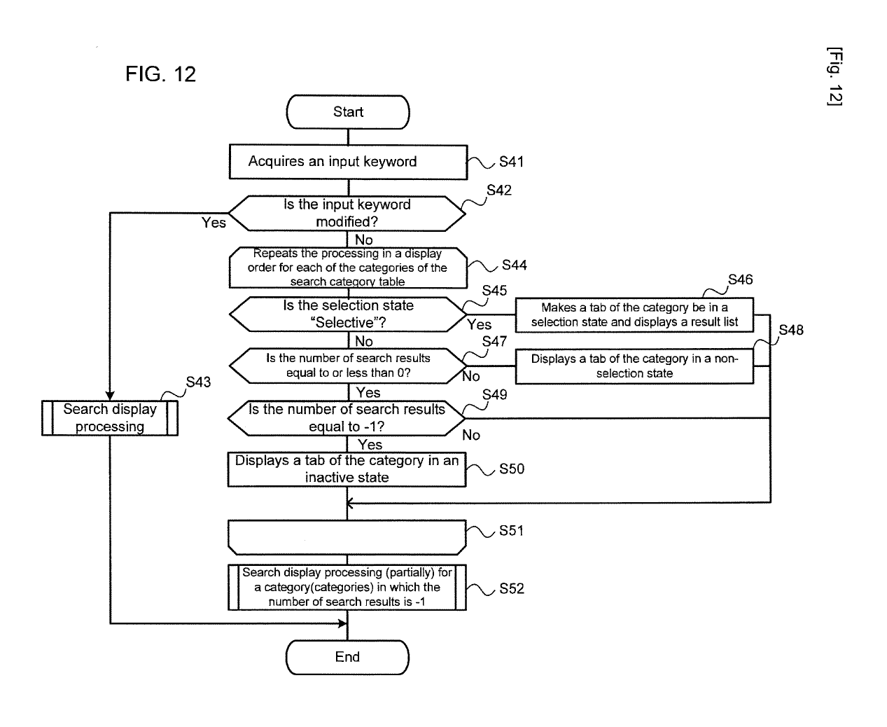

FIG. 12 is a flowchart of a search recovery processing in accordance with an embodiment.

The search recovery processing is a processing in the case in which a search is started using the view screen 1000 shown in FIG. 7 for instance.

In the case in which a search start button 1003 is pressed in the view screen 1000, the search display processing program 112 acquires a keyword that has been input to a keyword input/output region 1002 (step S41). In the next place, the search display processing program 112 judges whether or not the acquired keyword is modified from a time point of the last search (step S42). The judgment of whether or not a modification is executed can be decided by storing the last keyword into the memory 11 and by comparing the keywords with each other for instance.

In the case in which a modification is executed from a time point of the last search (Yes in the step S42) as a result, the search display processing program 112 executes the search display processing shown in FIG. 9 by using the said keyword (step S43).

On the other hand, in the case in which a modification is not executed from a time point of the last search (No in the step S42), the search display processing program 112 displays the initial screen of the search screen 40 and executes the processing of steps S44 to S51 in a repetitive manner in accordance with a display order of the display order 141b of a record for each of the categories of the record of the search category table 141 at a time point of the last search, which has been stored into the HDD 14.

In the first place, the search display processing program 112 judges whether or not a selection state 141c of a record of the corresponded category is “Selective” (step S45). In the case in which the selection state 141c of a record of the corresponded category is “Selective” (Yes in the step S45), a search result can be acquired in the last search and a selection for being displayed is indicated. Consequently, the program 112 makes a tab of the corresponded category be in an active state, acquires a search result that has been acquired in the last search is acquired from the HDD 14, a list of a search result is displayed on the tab screen 43 (step S46), and the processing proceeds to the step S51.

On the other hand, in the case in which the selection state 141c of a record of the corresponded category is “Nonselective” (No in the step S45), the search display processing program 112 judges whether or not the number of search results of a record of the corresponded category is equal to or less than 0, that is, whether or not a search is hit (step S47). In the case in which the number of search results of a record of the corresponded category is not equal to or less than 0 (No in the step S47), it is indicated that the last search is hit and completed. Consequently, the program 112 makes a tab of the corresponded category be in an active state (step S48) and the processing proceeds to the step S51.

On the other hand, in the case in which the number of search results of a record of the corresponded category is equal to or less than 0 (Yes in the step S47), the search display processing program 112 judges whether or not the number of search results of a record of the corresponded category is “−1”, that is, whether or not a search has been executed (step S49). In the case in which the number of search results is not “−1” (No in the step S49), the search result is 0 and it is indicated that the search has not been hit. Consequently, the program 112 proceeds the processing to the step S51 without displaying a tab of the corresponded category.

On the other hand, in the case in which the number of search results is “−1” (Yes in the step S49), it is indicated that as search has not yet been executed in the last search or a search is being executed in progress and has not been completed. Consequently, the program 112 displays a tab of the corresponded category in an inactive state on the search screen 40 (step S50).

After a repetitive processing of the steps S44 to S51 is executed for a record of all categories, a partial processing of the search display processing shown in FIG. 9 (the processing of the step S3 and subsequent steps) is executed for a category in which the number of search results is “−1”.

By the search recovery processing described above, in the case in which the last keyword has not been modified, the search result can be displayed using the last search result, and a search can be executed for only category in which a search has not yet been completed. Consequently, it is not necessary that a re-search is executed right from the beginning, and a search time can be shortened.

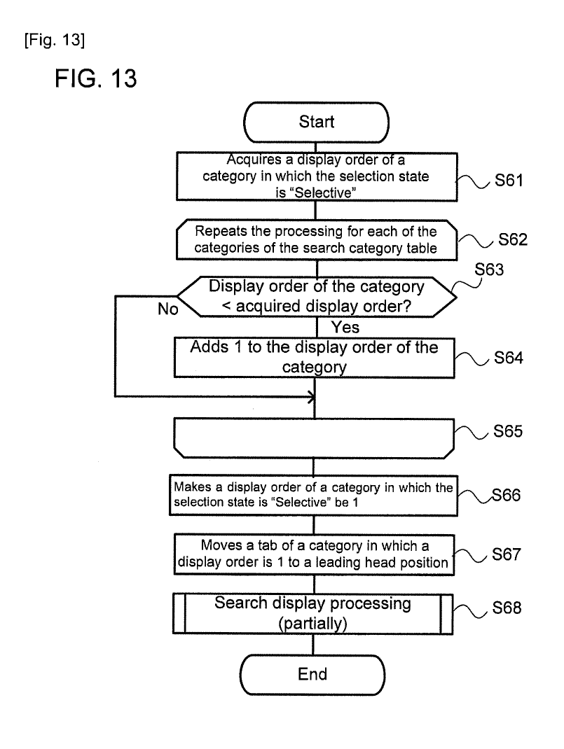

FIG. 13 is a flowchart of a re-search processing in accordance with an embodiment.

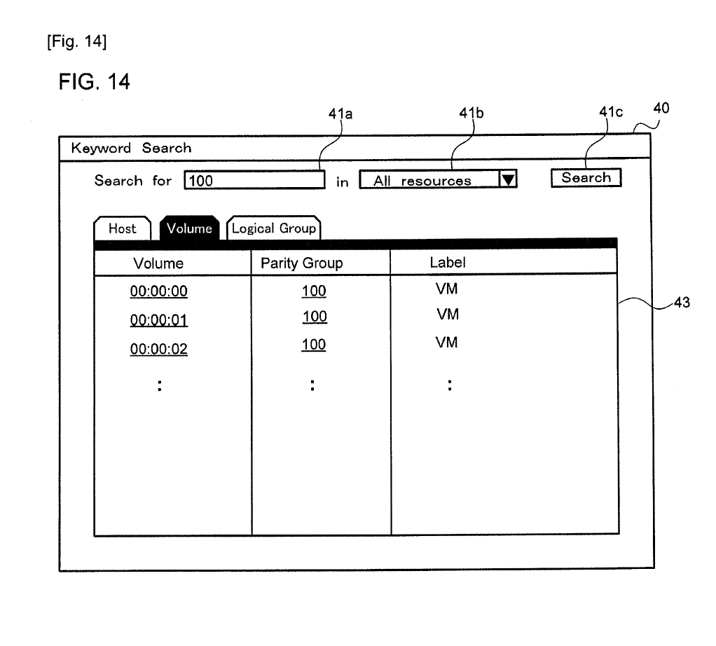

The re-search processing is a processing for corresponding to a situation in which a user wants to execute a re-search to the corresponded category by other keyword in the case in which a result that has been desired by a user has not been acquired. Consequently, in the situation in which a user wants to execute a re-search, a search screen as shown in FIG. 14 is displayed for instance.

In the search screen 40 shown in FIG. 14, a keyword (“100” in the figure) that has been input in the previous search is displayed in the keyword input field 41a. Moreover, a search hit tab is displayed in an active state, and a tab of a category (“Volume” in the figure) that a user focuses attention on is in an active state and in a selection state. In the tab screen 43, a screen of a tab that has been specified is displayed on the most front face, and a list of a search result is displayed in the screen. In the case in which a user wants to execute a re-search, the user inputs a keyword that is used for the re-search to the keyword input field 41a and presses the “Search” button 41c.

In the case in which the “Search” button 41c is pressed by a user, the search display processing program 112 execute a re-search processing.

In the first place, the search display processing program 112 acquires a display order of a category in which the selection state 141c of the search category table 141 is “Selective” (step S61).

In the next place, the search display processing program 112 executes the processing of steps S62 to S65 in a repetitive manner for each of the categories of the record of the search category table 141. More specifically, the search display processing program 112 judges whether or not a display order of a record of a category that is a processing target is smaller than a display order that has been acquired in the step S61 (step S63). In the case in which a display order of a record of a category that is a processing target is smaller than a display order that has been acquired (Yes in the step S63), the search display processing program 112 adds 1 to the display order of a record in order to set the display order to a category that is a processing target to be on the back of the display order that has been acquired (step S64). On the other hand, in the case in which a display order of a record of a category that is a processing target is not smaller than a display order that has been acquired (No in the step S63), the processing proceeds to the step S65 with executing nothing since the display order of a record is a display order that is on the back of the category that is a processing target. In the case in which the search display processing program 112 has executed and completed the processing of steps S62 to S65 in a repetitive manner for each of the categories of the record of the search category table 141, the search display processing program 112 modifies a display order of a category in which the selection state 141c of the record is “Selective” to be “1”, that is, a leading head (step S66).

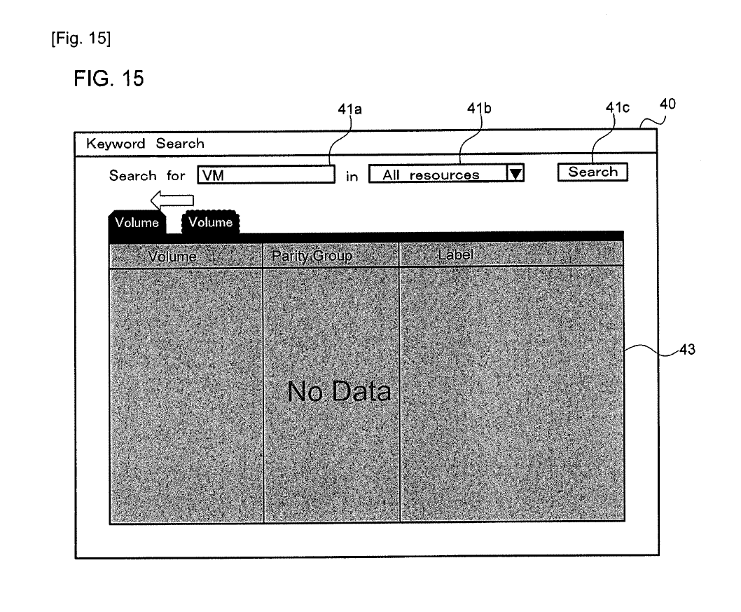

In the next place, the search display processing program 112 moves a tab of a category in which the display order 141b of the record of the search category table 141 is “1” to a leading head position. For instance, in the case in which a new keyword is input to the search screen 40 shown in FIG. 14, the search display processing program 112 moves a tab “Volume” that is in an active state in FIG. 14 in a direction of an arrow 1501 as shown in FIG. 15 and displays the tab “Volume” as a leading head tab (step S67). In the search screen 40, a new keyword (“VM” in this case) is displayed in the keyword input field 41a.

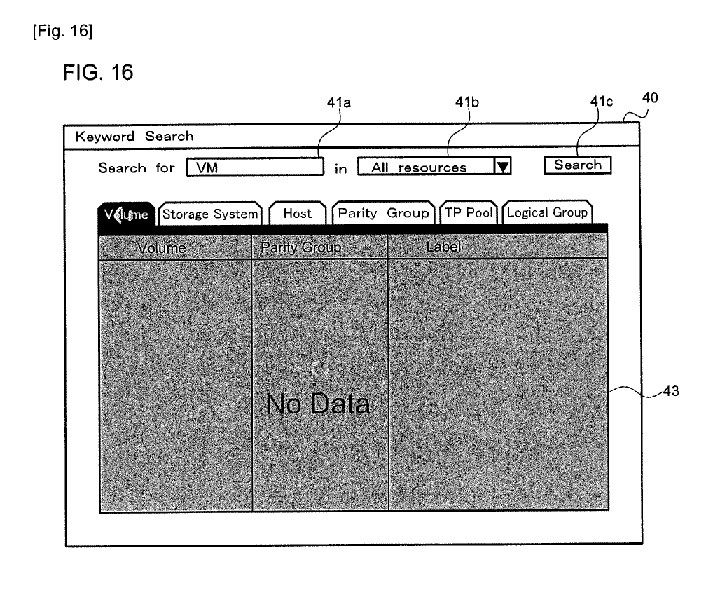

In the next place, the search display processing program 112 executes the processing of the step S2 and subsequent steps of the search display processing shown in FIG. 9 (step S68). In the step S2, as shown in FIG. 16, a tab of a category of which a display order is second or later is an inactive state.

By this re-search processing, a category of a tab that has been specified by a user is a search range at first in the re-search, whereby a search result for a category that is desired by a user can be provided at an early time.

In the next place, a first modified example of the embodiment will be described in the following.

In the above first embodiment, the entire name of a category is displayed to a tab of each category. However, in the case in which the entire name of a category is tried to be displayed to the tabs of all categories, all tabs cannot be displayed in a display region that can be displayed at one time in some cases depending on a length of a category name, the number of categories that are search targets, and a size of a search screen. In this case, there is a possibility that the contents of each tab cannot be confirmed in the case in which a display range is not scrolled in the right and left directions.

The first modified example controls a size of a tab that is displayed and a category name that is displayed in a tab in order to prevent this sort of problem.

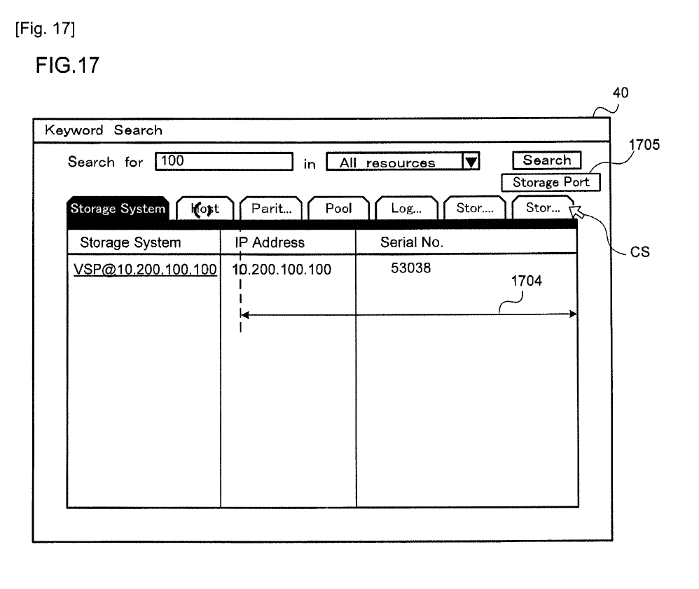

FIG. 17 is a view showing an example of a search screen in accordance with a first modified example of the embodiment.

In the first modified example, the search display processing program 112 makes a size (in particular, a horizontal width) of a priority tab be a normal size that can be displayed without reducing a category name or omitting a part of a category name, and makes a size (a horizontal width) of a non-priority tab be an exceptional size in which a category name can be reduced or a part of a category name can be omitted. The priority tab is a search hit tab “Storage System” and a tab “Host” of a search in progress for instance. The non-priority tab is a tab that is corresponded to a category that is waiting a search processing for instance. A normal size (a horizontal width) of a tab can be different depending on a length of a category name.

An exceptional size of a non-priority tab can be determined based on an available width 1704 for instance. The search display processing program 112 can calculate the available width 1704 by the following expression 1:

Available width 1704=(entire width that has been specified and that can display a tab at one time)−(width that is required for a display of at least one priority tab) (Expression 1)

The available width 1704 is a width in which the tabs of all search processing waiting categories are displayed. In the present embodiment, a width of a tab of each of the search processing waiting categories can be determined by dividing the available width 1704 by the number of search processing waiting categories. In the case in which the entire of the category name cannot be displayed in a tab that is provided with the determined horizontal width, a part of the category name can be omitted, an abbreviated name of the category name can be displayed, or the category name can be reduced for a display. Moreover, each width of a plurality of search processing waiting categories can be longer in the case in which a display order is earlier.

In the case in which a cursor CS is located on a tab of a search processing waiting category (that is, the mouse cursor is hovered over a tab), the search display processing program 112 displays the entire name of the category of the tab as a tool chip 1705. By this configuration, a user can comprehend a category name of a tab of an exceptional size in an appropriate manner.

By the first modified example, for a tab of a category that has been hit in a search and a category that is searched in progress, the entire name of the category can be confirmed in an appropriate manner. Moreover, since a type of a search processing waiting category is displayed, a progress situation of a search processing can be comprehended in an appropriate manner. Moreover, the entire name of the category can be displayed by hovering the mouse cursor over a tab even for the tab in which the entire of the category name is not displayed. Consequently, a user can comprehend a category that is corresponded to a tab in an appropriate manner.

In the next place, a second modified example of the embodiment will be described in the following.

The second modified example is a modified example for a display control of a tab.

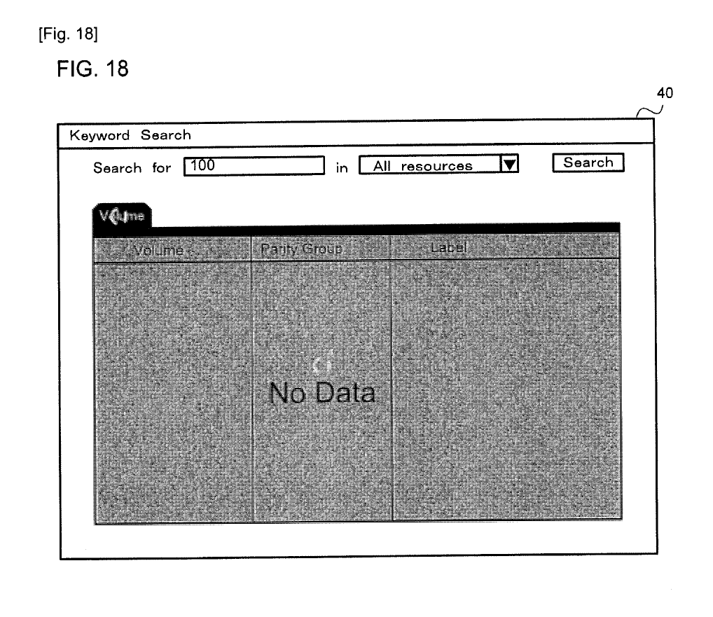

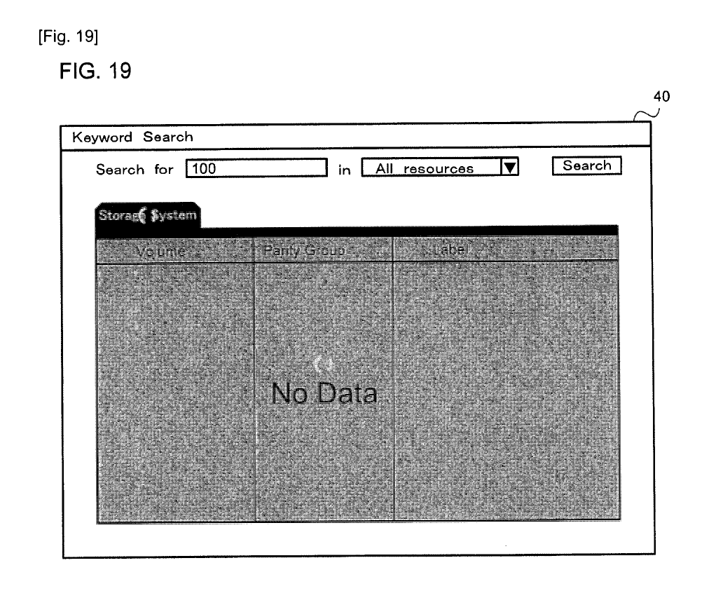

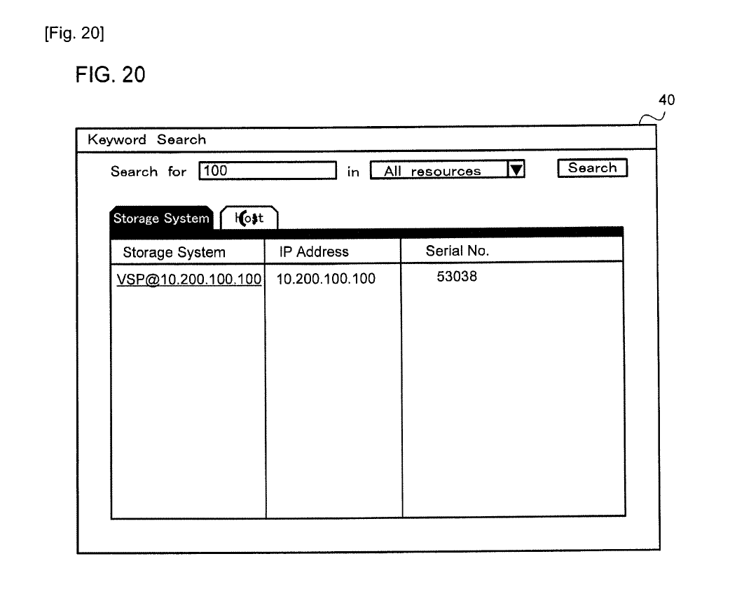

FIG. 18 is a view showing a first status of a search screen in accordance with a second modified example of the present invention. FIG. 19 is a view showing a second status of a search screen in accordance with a second modified example of the embodiment. FIG. 20 is a view showing a third status of a search screen in accordance with a second modified example of the embodiment.

In the second modified example, in the case in which the search display processing program 112 starts a search display processing, the search display processing program 112 does not display a tab for all categories that are search targets and displays a tab “Volume” of a category that is being searched in progress in the search screen 40 as shown in FIG. 18. In the case in which a search hit does not occur in a search to the category, the search display processing program 112 deletes a tab “Volume” that has not been hit (deletes the tab “Volume” by an animation for instance), displays a tab “Storage System” of a category that is the next search target, and executes a search to the category as shown in FIG. 19. In the case in which a search hit occurs in a search processing, the search display processing program 112 makes the search hit tab “Storage System” be in an active state, makes a tab “Host” of a category that is the next search target be in an inactive state to display the tab “Host”, and executes a search to the category as shown in FIG. 20.

By the second modified example, since only a tab of a category that has been hit and a tab of a category that is being searched in progress are displayed, a limited range in which a tab can be displayed can be utilized in an effective manner.

In the next place, a third modified example of the embodiment will be described in the following.

The third modified example is a modified example for a display control of a tab.

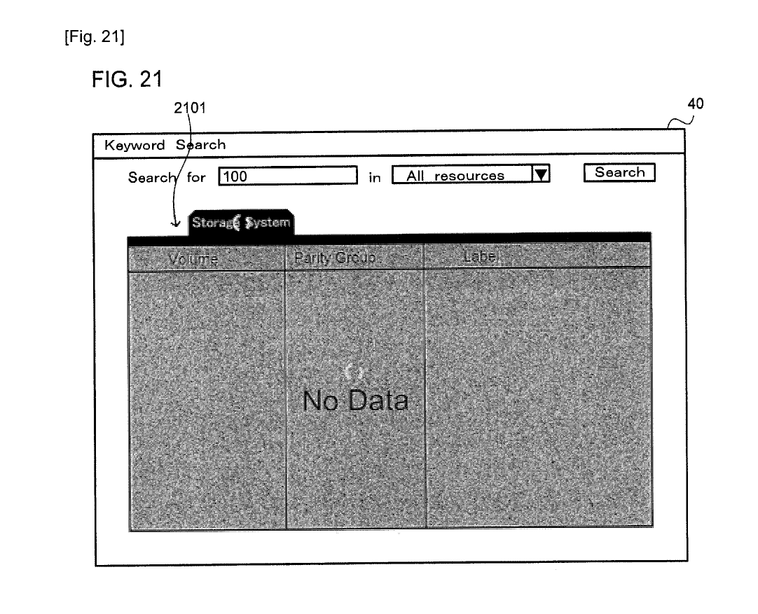

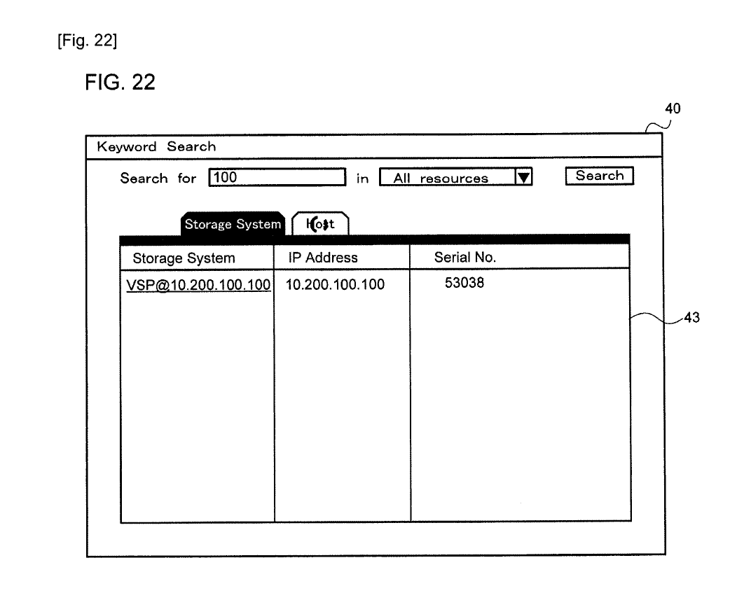

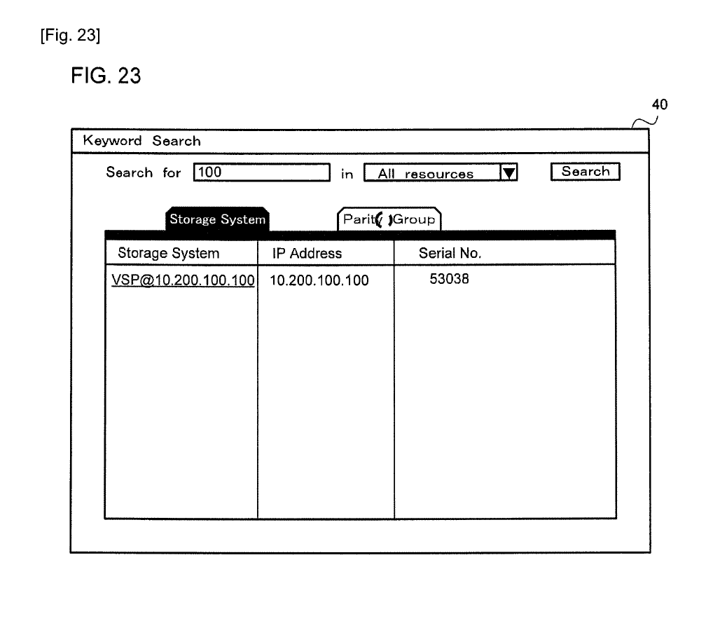

FIG. 18 is a view showing a first status of a search screen in accordance with a third modified example of the embodiment. FIG. 21 is a view showing a second status of a search screen in accordance with a third modified example of the embodiment. FIG. 22 is a view showing a third status of a search screen in accordance with a third modified example of the embodiment. FIG. 23 is a view showing a fourth status of a search screen in accordance with a third modified example of the embodiment.

In the third modified example, in the case in which the search display processing program 112 starts a search display processing, the search display processing program 112 does not display a tab for all categories that are search targets and displays a tab “Volume” of a category that is being searched in progress in the search screen 40 as shown in FIG. 18. In the case in which a search hit does not occur in a search to the category, the search display processing program 112 deletes a tab “Volume” that has not been hit to make a free region 2101, displays a tab “Storage System” of a category that is the next search target, and executes a search to the category as shown in FIG. 21. In the case in which a search hit occurs in a search processing, the search display processing program 112 displays a search result in the tab screen 43, makes a tab “Host” of a category that is the next search target be in an inactive state to display the tab “Host”, and executes a search to the category as shown in FIG. 22. Moreover, in the case in which a search hit does not occur in a search processing to the category, the search display processing program 112 deletes a tab “Host” that has not been hit to make a free region 2105, displays a tab “Parity Group” of a category that is the next search target, and executes a search to the category as shown in FIG. 23.

By the third modified example, since only a tab of a category that has been hit and a tab of a category that is being searched in progress are displayed and a displayed region of a tab of a category that has not been hit in a search is a free region, a user can comprehend an existence of a category that has not been hit in an appropriate manner. In the third modified example, a tab of a category that has been hit at first in a search can be displayed at the left end of a region in which a tab can be displayed for instance.

While the preferred embodiments and modified examples have been described above, the present invention is not restricted to the embodiments and modified examples, and various changes, modifications, and functional additions can be thus made without departing from the scope of the present invention.

In the above embodiment for instance, a tab of a corresponded category is not displayed in the case in which a search hit does not occur. However, a non-display of a tab is not necessarily executed.

In the above embodiment moreover, a time from a start of a non-display of a tab to a completion of a non-display of a tab (hereafter referred to an animation time length) can be modified in accordance with a variety of situations. For instance, in the case of a category in which a search has been hit in the last search and a search has not been hit in the subsequent search, an animation time length of a tab of the category can be longer than an animation time length of a tab that is corresponded to a category that has not been hit in the last search processing. By this configuration, a user is visually perceivable of that a search has not been hit in an effective manner.

Moreover, a view screen 1000 shown in FIG. 7 in the above embodiment can be provided with a screen part (such as a button) that is configured to return to a screen in the same state as a search screen in which a search is being executed in progress (FIG. 6). In the case in which the screen part (tool) is operated in that case, a processing of the step S44 and subsequent steps of the search recovery processing shown in FIG. 12 can be executed.

In the above embodiment moreover, a client 10 stores a display order to a category. However, a server 20 can store the information that indicates a display order to a category (for instance, the final display order and a display history) for every client (or every user) and can comprehend a display order based on the information that has been stored for instance.

Moreover, a code string that indicates a category or an object that displays a mark can also be adopted as substitute for a tab. In this case, a plurality of objects can be arranged under predetermined regulations (for instance, in a string along any of the horizontal, vertical, and diagonal directions, and in a clockwise or counterclockwise circular pattern from one starting point) in an order that conforms to a display order that is corresponded to the plurality of objects.

For “All Resource”, the search display processing program 112 can specify all categories and orders of search ranges for one search request. In this case, the search processing program 221 can switch a search range in accordance with the specified order, and can notify the search display processing program 112 of a category that is a search start and/or a search end every when a category that is a search range is switched. In the case in which the search display processing program 112 receives the notification, the search display processing program 112 can know that the notified category is being searched in progress and that a search of the last category is terminated.

Moreover, the client 10 can be a so-called virtual machine (for instance, a virtual desktop). In this case, a remote computer that can communicate with the client 10 as a virtual machine can be provided with an input/output device. The client 10 can receive an instruction of an input of a search condition and an instruction of a search execution from a remote computer, and can transmit the information for a display (for instance, a search result) to the remote computer.

### REFERENCE SIGNS LIST

10: Client
20: Storage management server
30: Storage system

1. A computer for executing a search of a resource of a computer system that includes a storage system and for displaying a result of the search, comprising:
a storage device; and
a control device that is configured to be coupled to the storage device, to display a category specification part that is an electronic screen part that receives a specification of a user desired category of a plurality of categories and a search condition input part that is an electronic screen part that receives an input of a search condition, to make a search engine execute a processing for searching a resource that is corresponded to a search condition that has been input to the search condition input part from a category that has been specified to the category specification part in accordance with an instruction of a search execution, and to display a result of the search,
wherein the storage device stores the category management information that includes the information that indicates a search order that is an order that is a search range for each category,
(A) the control device makes a default of the category specification part be in a state in which a special category that means that all of the plurality of categories is a search range is specified; and
(B) the control device:
(b1) makes the search engine execute a search in such a manner that a category that is a search range is switched in an order that conforms to a search order that is indicated by the category management information in the case in which the control device receives a search execution instruction in a state in which the special category is specified to the category specification part;
(b2) makes a display of a category object that is an object that indicates the category be in an active state that is a selectable state in the case in which a category in which a result of the search has been obtained among all the categories that conform to the special category is a search hit category that is a category in which a resource that is corresponded to the search condition has been found; and
(b3) makes a display of a category object of the category be in an inactive state that is a non-selectable state in the case in which a category in which a result of the search has been obtained among all the categories that conform to the special category is a non-search hit category that is a category in which a resource that is corresponded to the search condition has not been found.

2. A computer according to claim 1, wherein:
in the (A), the control device executes a display in such a manner that a plurality of category objects that are corresponded to all of the plurality of categories is arranged in a search order that is indicated by the category management information, and
in the (B), the control device executes the (b2) or (b3) in accordance with the result of the search every when a search is completed for the category.

3. A computer according to claim 2, wherein:
in the (b3), the category object in an inactive state is a category object that is invisible.

4. A computer according to claim 3, wherein:
in the (B), the control device makes a display of a category object that is corresponded to a category that is a search range be in an inactive state, displays a searching object that means that the category is searched in progress, changes a display of the searching object to meaning that a category of the next search order is searched in progress in the case in which a search of the category is completed, and executes the (b3) for the category after it is found that the category in which a search is completed is non-search hit.

5. A computer according to claim 4, wherein:
in the (b3), the control device makes a category object in an inactive state that is corresponded to a category of a non-search hit be invisible in an animation.

6. A computer according to claim 5, wherein:
there is an object display enable range that is a range in which an arrangement of the category object can be displayed,
in the (B), the control device closes up a category object in a visible state along a direction of an arrangement of the category object in the case in which a space occurs in an arrangement of the category object by making a category object that is corresponded to a category of a non-search hit be invisible, does not change a size of a category object in a selective state and a size of a category object that is corresponded to a category that is searched in progress, and changes a size of at least one category object of remaining category objects in a visible state other than a category object in which a size is not modified based on a size in a range other than a range of a category object in which a size is not modified in the object display enable range.

7. A computer according to claim 6, wherein:
the category object is a tab of a tab screen, and
the object display enable range is a horizontal width or a vertical width of the tab screen.

8. A computer according to claim 1, wherein:
all of category objects is invisible before an instruction of a search execution is received, and
in the (B), the control device displays a category object for a category that is searched in progress or a category of a search hit.

9. A computer according to claim 8, wherein:
in the (B), the control device makes a category object of the category be invisible again in the (b3) in the case in which a search is completed for a category and the category is non-search hit.

10. A computer according to claim 1, wherein:
in the (b3), the control device makes a category object in an inactive state that is corresponded to a category of a non-search hit be invisible in an animation.

11. A computer according to claim 1, wherein:
there is an object display enable range that is a range in which an arrangement of the category object can be displayed,
in the (B), the control device closes up a category object in a visible state along a direction of an arrangement of the category object in the case in which a space occurs in an arrangement of the category object by making a category object that is corresponded to a category of a non-search hit be invisible, does not change a size of a category object in a selective state and a size of a category object that is corresponded to a category that is searched in progress, and changes a size of at least one category object of remaining category objects in a visible state other than a category object in which a size is not modified based on a size in a range other than a range of a category object in which a size is not modified in the object display enable range.

12. A computer according to claim 11, wherein:
a name of a category is not displayed in accordance with a general rule for a category object before a size is changed, and
a name of a category is displayed in accordance with a general rule for a category object after a size is changed.

13. A computer according to claim 1, wherein:
(C) the control device updates the category management information in such a manner that a search order of one category is a head and changes an arrangement of the plurality of categories in such a manner that the one category is a head in the case in which another search condition is input and a search execution instruction is received for the one category of the plurality of categories.

14. A method for executing a search of a resource of a computer system that includes a storage system and for displaying a result of the search, comprising the steps of:
displaying a category specification part that is an electronic screen part that receives a specification of a user desired category of a plurality of categories and that makes a special category that means that all of the plurality of categories is a search range be specified by default and a search condition input part that is an electronic screen part that receives an input of a search condition;
making a search engine execute a processing for searching a resource that is corresponded to a search condition that has been input to the search condition input part from a category that has been specified to the category specification part in accordance with an instruction of a search execution in a state in which the special category is specified to the category specification part in such a manner that a category that is a search range is switched in an order that conforms to a search order that is indicated by the category management information;
making a display of a category object that is an object that indicates the category be in an active state that is a selectable state in the case in which a category in which a result of the search has been obtained among all the categories that conform to the special category is a search hit category that is a category in which a resource that is corresponded to the search condition has been found; and
making a display of a category object of the category be in an inactive state that is a non-selectable state in the case in which a category in which a result of the search has been obtained among all the categories that conform to the special category is a non-search hit category that is a category in which a resource that is corresponded to the search condition has not been found.

15. A search processing system comprising:
a computer for executing a search of a resource of a computer system that includes a storage system and for displaying a result of the search; and
a search engine that is coupled to the computer,
wherein the computer:
displays a category specification part that is an electronic screen part that receives a specification of a user desired category of a plurality of categories and that makes a special category that means that all of the plurality of categories is a search range be specified by default and a search condition input part that is an electronic screen part that receives an input of a search condition;
makes a search engine execute a processing for searching a resource that is corresponded to a search condition that has been input to the search condition input part from a category that has been specified to the category specification part in accordance with an instruction of a search execution in a state in which the special category is specified to the category specification part in such a manner that a category that is a search range is switched in an order that conforms to a search order that is indicated by the category management information;
makes a display of a category object that is an object that indicates the category be in an active state that is a selectable state in the case in which a category in which a result of the search has been obtained among all the categories that conform to the special category is a search hit category that is a category in which a resource that is corresponded to the search condition has been found; and
makes a display of a category object of the category be in an inactive state that is a non-selectable state in the case in which a category in which a result of the search has been obtained among all the categories that conform to the special category is a non-search hit category that is a category in which a resource that is corresponded to the search condition has not been found.
